(19) United States
(12) Patent Application Publication
(10) Pub. No.: US 2025/0348880 A1
(43) Pub. Date: Nov. 13, 2025

(54) COMPUTER SYSTEMS AND METHODS FOR MONITORING CUSTOMER FINANCIAL TRANSACTIONS FOR POTENTIAL FINANCIAL CRIMES

(71) Applicant: The PNC Financial Services Group, Inc., Pittsburgh, PA (US)

(72) Inventors: Amanda McCracken, Columbus, OH (US); Richard Abbott Hamilton, JR., Pepper Pike, OH (US); Ziyi Kang, Pittsburgh, PA (US); Firas Kotite, San Clemente, CA (US)

(21) Appl. No.: 18/658,592

(22) Filed: May 8, 2024

(51) Int. Cl. G06Q 20/40

(52) U.S. Cl. CPC G06Q 20/4016

(57) ABSTRACT

Computer systems and computer-implemented methods monitoring transactions of customers of a financial institution for potential financial crimes. A trained machine learning model computes a score of the interestingness of the financial institution's customers in terms of potential financial crimes, which scores can then be used to determine whether an alert should be issued for identified episodes of the customers. System can also look at repeat bad actors that are flagged across various scenarios and are attempting a different type of financial crime behavior. The model, once trained, can be deployed periodically to generate the customers' financial crime risk-related scores. The computed scores can then used as an input feature to improve financial crime alerting systems in identifying certain types of potential financial crime activities. If the alerting system determines that the customer's score is above certain, predefined threshold, the episode involving the customer can be sent for review by financial crime investigators for potential financial crime activity. The threshold varies from scenario to scenario.

### BACKGROUND

Money laundering is the process of moving illicit funds through the banking system so as to disguise the origin of the funds. Financial crimes detection models (FCDM) such as those used in Anti-money laundering (AML) and Fraud applications, leverage data from the banking system to identify unusual patterns in banking transactions that may be indicative of fraud or money laundering (financial crimes). FCDMs also attempt to financial crimes by analyzing the changes in specific customer/account information and the transactions performed on an account. Common applications in use by financial institutions, such as Oracle FCCM and Actimize, and Mantas, monitor the money flowing into and out of the banking system to detect possible money laundering. Such systems, however, do not consider a customer's behavior holistically.

### SUMMARY

In one general aspect, the present invention is directed to computer systems and computer-implemented methods for monitoring, for potential financial crimes, transactions of customers of a financial institution. Embodiments of the present invention train a machine learning model, particularly a set of decision trees, to compute a score, referred to herein as a “Transaction Monitoring Index” or “TM Index” score, of the interestingness of the financial institution's customers in terms of potential financial crimes, e.g., the customers' respective AML risks. The Transaction Monitoring Index (TM Index) scores can then be used to determine whether an alert should be issued for identified episodes of the customers.

The system can build input features from transaction and customer profile data and then use these features in a machine learning model to score the customers based on their probability of riskiness for financial crime activity. While most existing approaches rely on transaction aggregation strictly related to the scenario in question, embodiments of the present invention allow the user (e.g., a financial institution) to look at all types of transactions and across various windows of time. Embodiments of the present invention also allow the financial institution to look at repeat bad actors that are flagged across various scenarios and are attempting a different type of financial crime behavior.

In various embodiments, the model uses a Gradient boosting machine learning framework, such as Light Gradient Boosted Trees, as the machine learning algorithm to compute the customer TM Index score. Other embodiments may leverage other machine learning approaches, such as XGBoost for example. In various embodiments, the TM Index scores can range from 0.00 to 1.00, where greater scores indicate more similarity to previously identified suspicious activity. In various embodiments, the model, once trained, can be deployed periodically, such as weekly, to generate the customers' financial crime risk-related scores. The computed scores can then used as an input feature to improve financial crime alerting systems in identifying certain types of potential financial crime activities. If the alerting system determines that the customer's TM Index score is above certain, predefined threshold, the episode involving the customer is sent for review by financial crime investigators for potential financial crime activity. The threshold varies from scenario to scenario and is meant to enhance current existing alerting criteria.

Thus, embodiments of the present invention can take current financial crime scenarios and apply machine learning to catch more cases that would have otherwise been missed by traditional methods. These and other benefits that can be realized through embodiments of the present invention will be apparent from the description that follows.

### FIGURES

Various embodiments of the present invention are described herein by way of example in connection with the following figures.

FIG. 1 is a diagram of a system, including various computer systems, for training the model to generate the TM Index scores and to generate financial crime alerts based, at least in part, on the TM Index scores, according to various embodiments of the present invention.

FIG. 2 is flow chart depicting a process for training the machine learning model to compute the TM Index scores according to various embodiments of the present invention.

FIG. 3 is an illustration of a way to select training samples for training the TM Index model according to various embodiments of the present invention.

FIG. 4 is a diagram of a financial crime scenario generation system for identifying scenarios of potential financial crime activity according to various embodiments of the present invention.

FIGS. 5 and 6 are flows charts depicting, for different respective scenario types, whether to issue an alert for an identified scenario according to various embodiments of the present invention.

FIG. 7 is a diagram of the TM Index model training system according to various embodiments of the present invention.

### DESCRIPTION

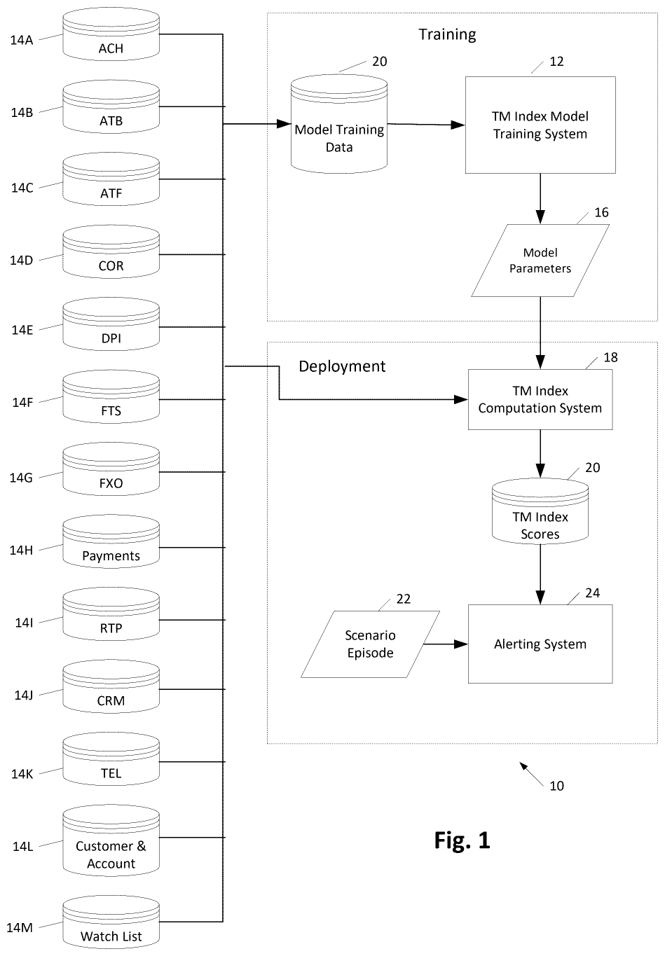

FIG. 1 is a diagram of a computer system 10 that can be used by a financial institution, for example, to identify transactions that might involve financial crime activity by customers of the financial institution, or put another way, to identify transactions that might require some sort of anti-money laundering (financial crime) alert for further investigation, according to various embodiments of the present invention. As described more fully herein, in various embodiments, a machine learning model is trained, by a model training system 12, to score customers of the financial institution based on how closely their transactions and attributes match those customers who were previously suspected of financial crimes (aka interestingness), e.g., a financial crime risk score for the customers. Greater scores indicate greater interestingness or greater financial crime risk. The score is sometimes referred to herein as a “TM Index” score, so the model training system 12 is sometimes referred to herein as the TM Index model training system 12. More details about the TM Index model training system are provided herein. The customers could be persons or organizations (i.e., companies, trusts, etc.). The model can be trained so that the higher the score, the more interesting the customer in terms of identifying financial crime activities (e.g., more likely to be involved in financial crime). In various embodiments, as explained herein, the model may comprise a Gradient boosting machine learning model, such as developed using a LightGBM (light gradient-boosting machine) or an XGBoost (eXtreme Gradient Boosting) framework, for example, particularly one trained via early stopping. Other tree-based models could also be used, such as a random fore or AdaBoost, for example. The model may use as features variables across a variety of databases 14A-M of the financial institution, described further below.

Once the model is trained, the model parameters can be stored in a memory or database of the financial institution, and the model can then be deployed, by a TM Index computation system 16, to score customers of the financial institution. The customer scoring can be performed periodically, such as once a week, so that the customers' TM Index scores are based on up-to-date information about the customers. Then, the TM Index score for a customer, along with data about a recent, identified episode 22 of the customer (a banking transaction or set of transactions that have hallmarks of potential financial crime activity), can be used by a financial crime alerting system 24 to determine whether a financial crime alert should be made about the customer's episode.

For convenience, the model trained by the TM Index model training system 12 is sometimes referred to herein as the TM Index model. As mentioned previously, the TM Index model may comprise a light gradient boosted tree model. As such, the TM Index might comprise a series of decision trees based on boosting. Generic gradient boosting at the m-th step would fit a decision tree hₘ(x) tree to pseudo-residuals. Let Jₘ be the number of its leaves. The tree can partition the input space into Jₘ disjoint regions Rim, . . . , R_{J}_{ₘ}ₘ and predicts a constant value in each region. Using the indicator notation, the output of hₘ(x) for input x can be written as the sum:

$${h}_{m} ( x ) = {\sum }_{j = 1}^{{J}_{m}} {b}_{jm} {1}_{{R}_{jm}} ( x )$$

where bⱼₘ is the value predicted in the region R_{J}_{ₘ}.

Then the coefficients bⱼₘ can be multiplied by some value, chosen using line search so as to minimize the loss function, and the model is updated as follows:

$${F}_{m} ( x ) = {F}_{m - 1} ( x ) + {γ}_{m} {h}_{m} ( x ) ,$$

$${γ}_{m} = arg {min}_{γ} {\sum }_{i = 1}^{n} L ( {y}_{i ,} {F}_{m - 1} ( {x}_{i} ) + γ {h}_{m} ( {x}_{i} ) ) .$$

As such, the output of the model can be the sum of the outputs of each tree.

In various embodiments, this algorithm could be modified so that it chooses a separate optimal value γⱼₘ for each of the tree's regions, instead of a single γₘ for the whole tree. The coefficients from bⱼₘ the tree-fitting procedure can be then simply discarded so that the model update rule becomes:

$${F}_{m} ( x ) = {F}_{m - 1} ( x ) + {\sum }_{j = 1}^{{J}_{m}} {γ}_{jm} {h}_{m} ( x ) ,$$

$${γ}_{m} = arg {min}_{γ} {\sum }_{{x}_{i} ∈ {R}_{jm}}^{} L ( {y}_{i ,} {F}_{m - 1} ( {x}_{i} ) + γ ) .$$

With early stopping, a least number of iterations that is sufficient to build the model so that it generalizes well to unseen data can be found and used. A “validation fraction” can be specified that denotes the fraction of the whole dataset that will be kept aside from training to assess the validation loss of the model. The gradient boosting model is then trained using the training set and evaluated using the validation set. When each additional stage of regression tree is added, the validation set is used to score the model. This is continued until the scores of the model in the stage do not improve by at least a threshold. After that the model is considered to have converged and further addition of stages (e.g., trees) is “stopped early.” The number of stages (e.g., trees) of the final model is available, for example, at the attribute “n_estimators” as described further below.

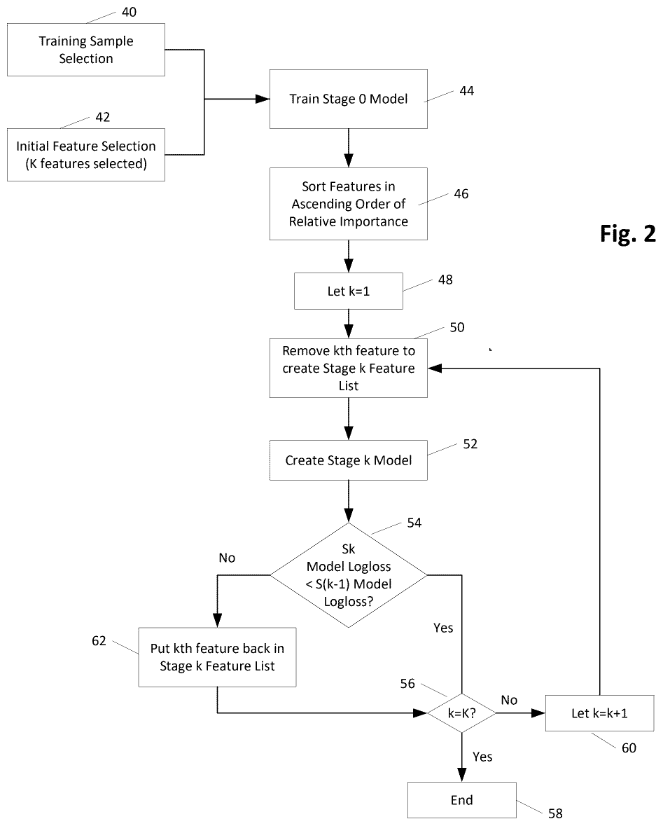

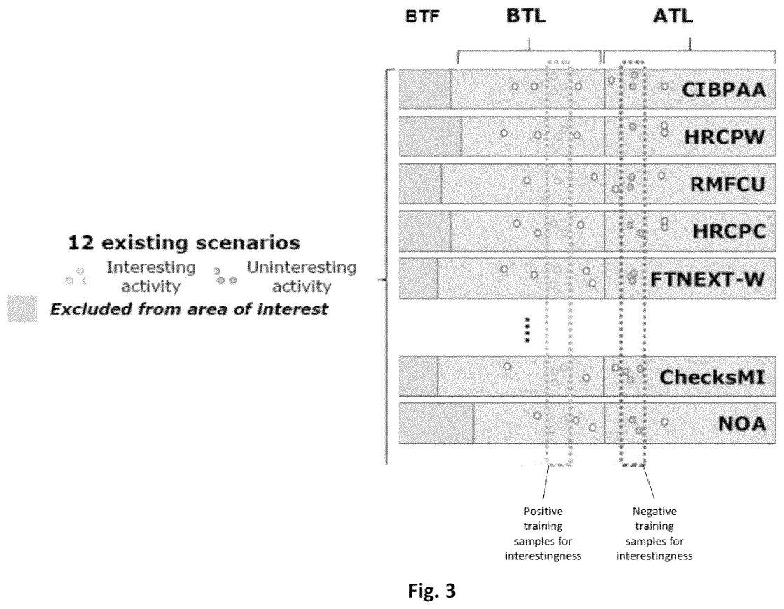

FIG. 2 is a generalized flow chart of a process for training the TM Index model according to various embodiments of the present invention. The TM Index may be trained so that the score for each customer, at a particular time, is in the range of 0.00 to 1.00, inclusive, with higher scores indicating more interestingness in terms of financial crime, i.e., more financial crime risk. First, at step 40 a set of training samples is acquired and at step 42 a set of features of the model are selected. For step 40, in various embodiments, a system like Oracle FCCM could be used for identification of the samples. Other systems can also be used to identify training samples. Oracle FCCM is an anti-financial crime solution designed for financial institutions. It enables users to detect, investigate, and report suspected financial crime activity to comply with current and future regulations and guidelines, automate the consistent surveillance of accounts, customers, correspondents, and third parties in transactions across business lines, identify potential perpetrators across customer lifecycle stages with risk derivation and risk scoring models, and perform real-time monitoring and interdiction of transactional activity. Features include risk-based monitoring, comprehensive transparent behavior detection library, regulatory reporting, case management, and real-time alert correlation. Oracle FCCM has several financial crime scenarios, such as, to name a few examples: anomalies in ATM or bank card for foreign transactions; address associated with multiple, recurring external entities; income; source of funds; customer borrowing against new policy; significant cash transactions; and many others. See Release Notes, Oracle Financial Services, Release 6.2.1, September 2013, incorporated herein by reference. In various embodiments, to select the training samples, every customer of the financial institution who was in an area of interest for any of the predefined Oracle FCCM scenarios on a particular processing date, whether above or below the line, could be in included in the modeling population. FIG. 3 illustrates an example of the sample selection process. FIG. 3 shows several Mantas scenarios (CIBPAA, HRCPW, RMFCU, FTNEXT-W, ChecksMI, and NOA) and shows regions for “above the line” (“ATL”), “below the line” (BTL), and “below the inclusion criteria” (“BIC”). The samples preferably are selected above and below the line, within the area of interest, and preferably not below the inclusion criteria. In various embodiments, customers below the line that were determined to be interesting could have a training label of 1.0 for training the TM Index model and customers above the line that were determined to be not interesting could have a training label of 0.0 for training the model.

In various embodiments, a stratified sampling model (SSM) could be built using a gradient boosted (e.g., XGBoost) model that would rank order customers based on the likelihood of interestingness for reviewed observations. That is, for example, the modeling population could be grouped into known and unknown populations. The known population could comprise customers who were reviewed at a particular time and for which their interestingness disposition is known, whether interesting (positive samples) or uninteresting (negative samples). The unknown population could comprise customers that were not previously known. The SSM could be used to score preliminarily customers without TM Index scores in the modeling population to target more of the sample towards population regions where interesting activity was expected to be. That is, for example, by building a stratification model on the known population to define high, medium, and low risk segments of the population, and then applying this segmentation to the unknown population, areas where interesting activity was more likely to be concentrated could be targeted for selection of the sample. Also, down sampling could be used to increase the proportion of interesting elements when developing the SSM on the known population.

At step 42, variables to use as features of the decision trees are selected. Each internal node of a decision tree can represent a test on a selected feature, with each leaf (or endpoint) of the tree representing a class label (e.g., a TM Index score), and branches representing conjunctions of features that lead to those class labels. As shown in FIG. 1, data from various financial-transaction and/or financial institution-based databases 14A-M can be used for selection of the variables as the features for the TM Index model. The databases 14A-M, in various embodiments, can comprise: a database 14A of ACH transactions; a database 14B of automated teller transactions (ATB); a database 14C of automated transactions; a database 14D of core deposits (COR); a database 14E of debit card processing transactions (DPI); a database 14F of funds transfer systems transactions (FTS); a database 14G of foreign exchange transactions (FXO); a database 14H of real time payment transactions (personal and/or commercial/institutional banking); a database 14I of real time payment (RTP) transactions; a customer relationship management (CRM) database 14J; a database 14K of teller transactions (TEL); a database 14L of customer and account data; and a database 14M of watch lists, such as from governmental organizations. In other embodiments, different databases with different data could be used to draw the features. Data for the selected customers for the selected variables can be stored in a model training database 20, which may be embodied with a Hadoop database or other suitable database, particularly massive amounts of data.

In various embodiments, hundreds of potential variables can be selected as features at step 42. The variables/features can be counts or amounts over different lookback periods, such as 35, 60 and 90 days. The variables may be grouped into categories of data, such as: ACH transactions; active vs. inactive customers; overall transaction volumes; address cash-flagged red flags; check transactions; electronic fund transfers; customer attributes (e.g., tenure, account ownership, etc.); red flags involving monetary instruments; red flags involving online payment systems; watch list customers; and wire transactions. The variables can be binary (0 or 1) or non-binary, like aggregate amounts of certain types of transactions over the various lookback periods. Examples of binary variables include whether various types of accounts were opened in the various lookback periods. Examples of non-binary variables include: number of accounts for customer over the various lookback periods; aggregate amounts of different types of transactions over the various lookback periods; total number and amounts of different types of transactions (e.g., ACH, debit, wire, etc.) over the various lookback periods; ratios and percents of debit to cash transaction amounts and/or transactions over the various lookback periods; total number and amounts of cashier checks and/or non-cashier checks over the various lookback periods; number of different account types over the various lookback periods; number of distinct jurisdictions where customer has accounts over the various lookback periods; total number of cash transactions greater than and/or less than various thresholds over the various lookback periods; length of customer relationship since opening first account; total amounts of various types of credit accounts over the various lookback periods; number of non-zero transaction weeks over the various lookback periods and account holdings and aggregate transaction amounts for various types of accounts and transactions for those non-zero transaction weeks; etc. The ultimate set of features included in the final model can be revised as explained herein.

Once the initial set of K features are selected and the training samples are selected, the TM Index model training system 12 can train, through machine learning, the initial “Stage SO” model at step 44. As mentioned herein, the model can comprise a light gradient boosted tree model. The model can be trained with tunable parameters, such as, for example: learning rate (which controls the contribution of each additional tree); number of decision trees to use (e.g., 1 to 20,000); maximum depth of the individual trees (e.g., regression estimators) (e.g., 1 to 10,000); minimum sum of instance weight needed in a child tree (e.g., 0.01 to 100,000); number of leaves in one tree (e.g., 2 to 10,000); minimum loss reduction required to make a further partition on a leaf node of the tree (e.g., 0 to 100); and early stopping thresholds. The hyperparameters can be trained using DataRobot, for example, which is a machine learning/AI platform for automating, assuring, and accelerating predictive analytics, including light gradient boosted tree models. The platform draws from several open-source machine learning R and Python-based libraries, including scikit-learn, H2O, TensorFlow, Vowpal Wabbit, Spark ML, and XGBoost. It can automate the selection of the ideal features, algorithms, and parameter values for building each model.

Next, at step 46, the initial K features can be sored in ascending order based on relative importance, such that the first feature in the list has the smallest relative importance. Feature importance can be computed using, for example, coefficient statistics between each feature and a target variable. Then, at step 48, a counter “k” is set to 1 so that, at step 50, the kth feature in the ascending list of relative importance (i.e., the feature with the least relative importance) is removed from the feature set, such that the updated feature set has (K-k) features. Then, at step 52, the TM Index model training system 12 can train, through machine learning, the Stage k model based on the (K-k) feature set (much like the Stage 0 model was trained at step 44). At step 54, the TM Index model training system 12 can compare the performance of the Stage k model to the Stage (k−1) model (i.e., the prior model). The comparison may be based on a log-loss computation, which is indicative of how close the prediction probability is to the corresponding target, penalizing inaccurate predictions with higher value, such that lower log-loss indicates better model performance. Thus, at step 54 if the Stage k log loss is less than the Stage (k−1) model, the newer model has better performance and the process advances to step 56, where a check is made of whether k-K, or in other words, whether the process has cycled through all of the K features in the original feature set. If k equals K at step 56, then the process of training the model is complete at step 58 and the Stage K model is ready for deployment. However, if at step 56 k does not equal K, then the counter k is incremented by one at step 60 and the process returns to step 50 to remove the new least significant feature from the current feature list so that the next model stage is created at step 52.

Returning to decision step 54, if the Stage k model does not perform better than the Stage (k−1) model, then the process advances to step 62, where the kth feature is put back into the Stage k feature list. Then the process advances to step 56 where, as mentioned above, a check is made of whether k-K. If k equals K at step 56, then the process of training the model is complete at step 58 and the Stage K model is ready for deployment. If not, k is incremented at step 60 and the process returns to step 50.

Returning to FIG. 1, once the Stage K model is trained, its model parameters can be stored in a database at step 16 so that the model is ready to be deployed. The parameters can include the features used to make the decisions at each node in the decision trees. The model parameters can be saved, for example, as a .pkl file, a JSON file, a TensorFlow Keras (tf.keras) API, a Joblib file, a PMML file, or a HDF5 format file.

In deployment, on a periodic basis, such as weekly for example, a TM Index computation system 18 can compute the TM Index scores for customers based on, for each customer, the updated data for the customer from the databases 14A-M, and based on the latest model parameters 16 for the TM Index model. The updated TM Index scores can be stored in a database 20, such as in a RDMS database or a Hadoop database, for example. Again, in various embodiments, the TM Index scores can range from 0.00 to 1.00, where lesser scores indicate lesser interestingness (or lesser financial crime risk), and greater scores indicate greater interestingness (or greater financial crime risk). That way, when the financial crime alerting system 24 receives data about an identified scenario episode 22 involving a customer of the financial institution (transaction data for the customer indicative of potential financial crime activity under one of the monitored scenario types), the alerting system 24 of the system 10 can determine whether an financial crime alert should be made for the scenario episode based on the data for the scenario episode and based the TM Index score for the customer involved in the identified scenario episode.

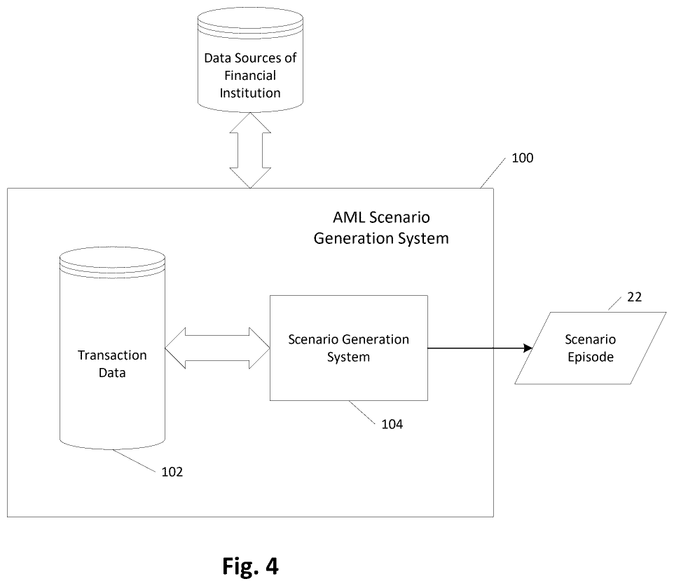

To generate the scenario episodes 22, the financial institution can have a financial crime scenario generation system 100, such as shown in FIG. 4, which ingests transaction data from numerous sources of the financial institution, such as the databases 14A-M and/or other data sources. The data may be ingested after every business day, for example, and stored in a database 102 (such as a Hadoop database). Periodically, such as once a week, the scenario generation computer system 104 can analyze the transaction data 102 to identify transactions that are indicative or suggestive of a pre-determined number of financial crime scenarios. Each scenario monitors for a different behavior topology. Example scenarios that can be monitored include, but are not limited to: patterns of sequentially numbered checks or other monetary instruments (CHECK MI); change in behavior for foreign activity (CIB-FA); significant change in behavior from previous average activity (CIB-PAA); patterns of funds transfers between customers and external accounts for ACH or wire transactions (FTN-EXTERNAL-ACH and FTN-EXTERNAL-WIRE); patterns of funds transfers between internal accounts and customers (FTN-INTERNAL); cash or wire transactions with a high-risk counterparty (HRT-HRCP-CASH and HRT-HRCP-WIRE); network of seemingly unrelated accounts, external entities and customers (NOA); rapid movement of funds, account and client focused (RMFAC and RMFCU); and patterns of conducting significant transactions in cash and cash equivalents that aggregate above reporting threshold (STRUCT). Of course, in other embodiments, fewer, more and/or different scenarios could be used. In various embodiments, the scenario generation system 104 can be embodied with an Oracle FCCM or similar system that monitors transaction data for the aforementioned scenario types.

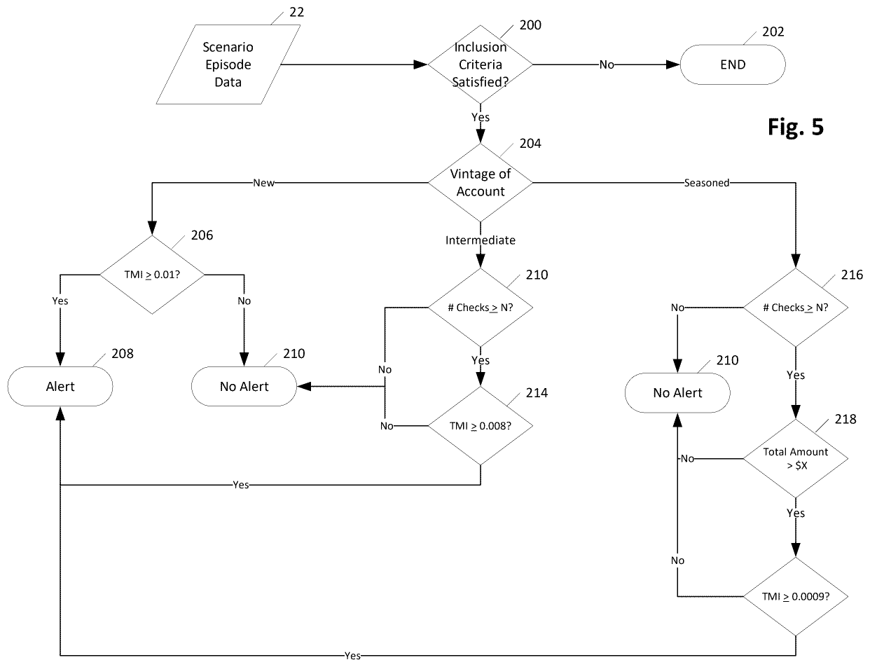

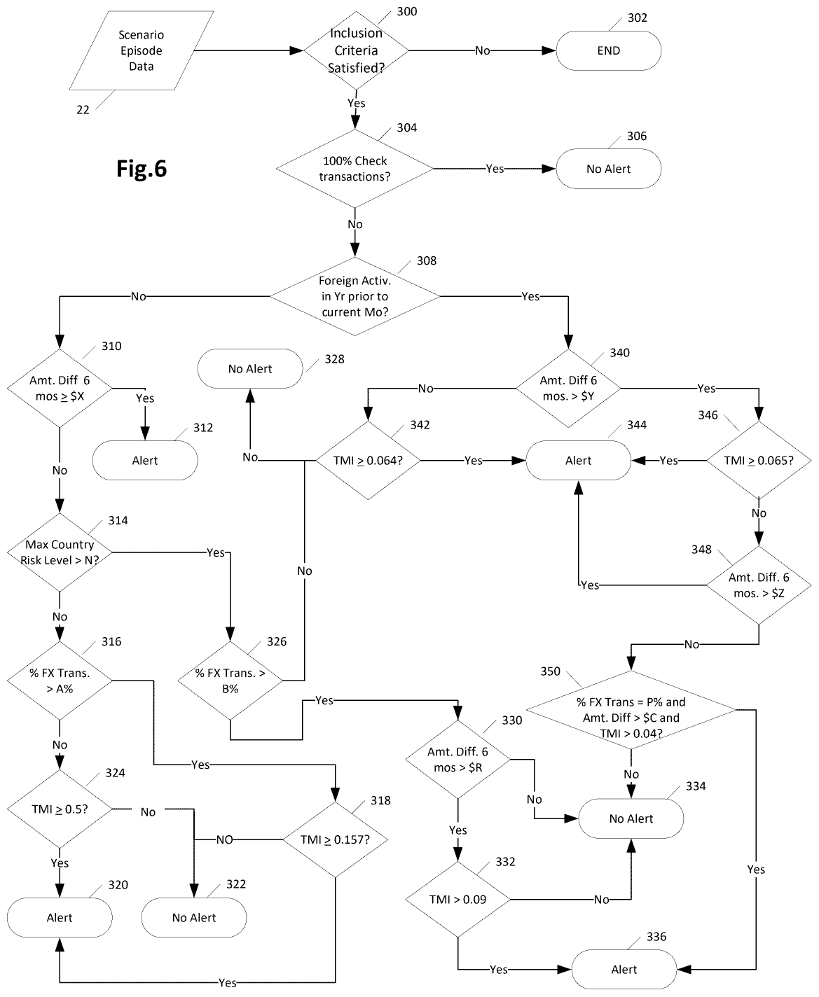

FIGS. 5 and 6 show example process flows (e.g., filters) that the financial crime alerting system 24 can employ to determine whether a particular scenario episode 22 requires a financial crime alert to be made. Both depicted examples use the TM Index score 20 for the individual or organization that is the subject of the scenario episode 22 as part of the determination process of whether an alert should be made. FIG. 5 is an example process flow for an individual (as opposed to an organization) for a CHECKS MI scenario and FIG. 6 is an example process flow for an individual for a CIB-FA scenario. Each type of scenario detected by the financial crime scenario generation system 100 can have a corresponding set of process flows (e.g., individual and organization) for the alerting system 24. Also, the process flows examples depicted in FIGS. 5 and 6 are illustrative. Different process flows, which use in part the TM Index scores 20, can be used and designed for triggering alerts depending on the risk level of the financial institution implementing the alerting system 24 and/or changing financial crime laws and regulations, for example.

As mentioned above, the example of FIG. 5 is for a CHECKS-MI scenario. This scenario looks for patterns of sequentially numbered checks and monetary instruments to detect the deposit of sequentially numbered checks into an account. The concern is that writing numerous checks to the same party can be used as a method to aid in the layering and integration of illicit funds. This scenario identifies accounts that have substantial risk as a result of the placement of large numbers of sequentially numbered checks or monetary instruments into the banking system. The scenario can monitor sequentially numbered checks or monetary instruments such as personal and traveler's checks. The pattern can identify a series of sequentially numbered checks or monetary instruments from the same remitter and same instrument name.

FIG. 5's depicted process flow starts at step 200, where the alerting system 24 determines whether the inclusion criteria (aka thresholds) for analysis are satisfied. A series of sequentially numbered checks or monetary instruments can be considered an episode identified by the scenario generation system 104. With that in mind, the inclusion criteria can include, for example: (i) the amount of each transaction in a series is greater than some minimum threshold (e.g., $200 USD); (ii) the check numbers between two consecutive transactions must be less than or equal to a maximum skipped last digit (e.g., 3); (iii) the number of consecutive transactions in the episode must be greater than or equal to some minimum transaction count (e.g., 2); (iv) the sum of the transactions within an episode must be greater than or equal to some minimum amount (e.g., $2000 USD); (v) the number of episodes must be greater than or equal to some minimum episode count; (vi) the sum of all episodes must be greater than or equal to some minimum amount per episode; (vii) the average transaction amount of all transactions contained in episodes is greater than or equal to a minimum average transaction amount; and/or (viii) the average episode amount of all episodes is greater than or equal to some minimum average episode amount. The account filters preferably only apply to the beneficiary; that is, preferably only the beneficiary is considered, not the remitters. If different remitters exist for each occurrence, an alert may not be generated under this scenario. To avoid redundant alerts, the detection process need not produce an alert unless at least one transaction of interest has occurred in the frequency period (e.g., seven days).

If the inclusion criteria are not met, a “not alert” is issued at step 202. If the inclusion criteria are satisfied, the process can advance to step 204, described below. Of course, in other embodiments, fewer, more and/or different inclusion criteria could be used at step 200.

At step 204, the alerting system 24 filters the scenario based on the vintage of the individual's account, e.g., new, intermediate, or seasoned. As one example, at account less than six months old can be considered new; an account between six and thirty months old can be considered intermediate; and an account greater than thirty months old can be considered seasoned. Of course, in other embodiments, different cutoffs for the different vintage categories could be used; and fewer or more vintage categories could be used.

If the account is new, the process can advance to step 206, where the alerting system 24 checks the individual's TM Index score. If the score is greater than some threshold value (e.g., 0.01), recalling that greater TM Index scores indicated greater interestingness for financial crime activities by a customer, the alerting system can determine that a financial crime alert should be issued at step 208. Conversely, if the individual's TM Index score is less than the threshold, then no alert is issued at step 210.

Returning to step 204, if the individual's account has an intermediate vintage, the process advances to step 212, where the alerting system 24 checks the total number of checks involved in the scenario. If it is less than some threshold number N (e.g., five), the alerting system 24 can determine that no alert is necessary at step 210. Conversely, if the number of checks is equal to or greater than the threshold N, the process can advance to step 214 where the alerting system 24 checks the TM Index score for the individual. If it is greater than some threshold (e.g., 0.08), then an alert is issued at step 208.

Returning to step 204, if the individual's account has a seasoned vintage, the process advances to step 216, where the alerting system 24 checks the total number of checks involved in the scenario. The same or a different threshold can be used relative to step 210. If the number of checks is less than the threshold number, the alerting system 24 can determine that no alert is necessary at step 210. Conversely, if the number of checks is equal to or greater than the threshold N, the process can advance to step 218, where the alerting system 24 checks the aggregate transaction amount of the checks involved in the scenario. If it less than some threshold amount $X (e.g., $9000 USD), no alert is issued at step 210. Conversely, if the aggregate transaction amount of the checks involved in the scenario is greater than or equal to the threshold amount $X, the process can advance to step 220, where the TM Index score for the individual is checked. If the individual's TM Index score is greater than some threshold (e.g., 0.0009), then an alert is issued at step 208. Otherwise, no alert is issued at step 210. Of course, in other embodiments, different process flows can be used using the TM Index scores to determine whether an alert is warranted for this scenario.

FIG. 6, as mentioned above, is an example process flow for a CIB-FA scenario. A sudden change in transaction activity may be suspicious and warrant additional investigation. The large number of transactions within an account on a daily basis can make it difficult to detect changes or anomalies in account activity. This scenario can identify accounts that may be considered to be at risk by monitoring for foreign wire and foreign check transactions to detect significant changes from the previous monthly foreign transaction activity. This scenario can monitor behavior changes in foreign transactions for seasoned accounts. A seasoned account can be defined as an account that is opened on or before a defined parameter, Min Open Days, from the current date. Behavior profiles can be based on activity during the twelve months prior to the current month. The current month's credit foreign activity can be compared to the credit foreign activity from the previous twelve months to generate alerts for credit behavior changes that are significant. Debit foreign activity can be monitored in the same manner. However, the scenario can generate one alert only for the credit foreign behavior change or the debit foreign behavior change.

For illustrative purposes, FIG. 6 depicts a process flow for an individual with a credit account with the financial institution. Different process flows could be employed, for example, for an individual with a debit account, a credit account for a small business, a debit account for a small business, a credit account for an organization, and/or a debit account for an organization. FIG. 6 starts at step 300, where the alerting system 24 determines whether the inclusion criteria requirements are satisfied. In various embodiments, the inclusion criteria can include that: (i) an earliest account open date for the individual is less than a minimum number of days from the current day (e.g., the account is relatively new); (ii) the aggregate current month foreign credit transactions amount is greater than or equal to some minimum current month foreign amount threshold; (iii) the aggregate current month foreign credit transactions amount is greater than or equal to some aggregate current month credit transactions amount threshold times a minimum percentage of foreign amount; and (iv) the aggregate current month foreign credit transactions amount minus a peak monthly foreign credit transactions amount of the previous twelve months is greater than or equal to a peak monthly foreign credit transactions amount of the previous twelve months times a minimum percentage of foreign amount increase. Of course, in other embodiments different inclusion criteria could be used.

If the inclusion criteria are not satisfied, the process advances to step 302 where it is ended without an alert being issued. Alternatively, if the inclusion criteria are satisfied, at step 304 the alerting system 24 determines if all the transactions in the scenario episode 22 are check transactions. If so, no alert is issues at step 306. However, if not all of the transactions are checks, the process can advance step 308, where the alerting system 24 determines if the customer had foreign activity in the year prior to the current month. If not, at step 310, the alerting system 24 determines if the amount difference over the last six months is greater than or equal to some threshold $X (e.g., $12,000 USD). If so, an alert is issued at step 312. Otherwise, the process can advance to step 314, where the alerting system 24 checks, of the countries for originating wire transaction, the country with the highest risk level and whether that risk level is greater than or equal to some threshold N (e.g., 7). If not, the process advances to step 316, where the alerting system 24 assess whether the percentage of foreign transactions by the customer is greater than some threshold percentage A (e.g., 98%). If so, the process can advance to step 318, where the alerting system 24 determines whether the customer's TM Index score is above or below some threshold (e.g., 0.157). If the individual's score is greater than or equal to this threshold, an alert is issued at step 320. If not, no alert is issued at step 322.

Going back to step 316, if the percentage of foreign transactions is not greater than the threshold percentage, the process can advance to step 324, where the alerting system 24 determines whether the customer's TM Index score is above or below some threshold (e.g., 0.5). If the individual's score is greater than or equal to this threshold, an alert is issued at step 320. If not, no alert is issued at step 322.

Returning to step 314, if the maximum country risk level for an originating wire is not greater than the applicable threshold, the process can advance to step 326, where the alerting system 24 assess (similar to step 316) whether the percentage of foreign transactions by the customer is greater than some threshold percentage B (e.g., 95%). If not, no alert is issued at step 328. Conversely, if the percentage of foreign transactions by the customer is greater than or equal to the applicable threshold percentage B, the process can advance to step 330, where (similar to step 310) the alerting system 24 determines whether the amount difference over the last six months is greater than or equal to some threshold $R (e.g., $7,000 USD). If so, at step 332 the alerting system checks the individual's TM Index score. If it is greater than or equal to some threshold (e.g., 0.09), an alert is issued at step 334. Conversely, if the individual's TM Index score is less than the threshold (e.g., 0.09), not alert is issued at step 336.

Going back to step 308, if the customer had foreign transactions in the year prior to the current month, the process can advance to step 340, where (similar to step 310) the alerting system 24 determines whether the amount difference over the last six months is greater than or equal to some threshold $Y (e.g., $30,000 USD). If not, the process advances to step 342, where the alerting system 24 determines whether the individual's TM Index score is greater than some threshold (e.g., 0.064). If not, no alert is issued at step 328. If the individual's TM Index score is greater than the applicable threshold, the process advances to step 344 where the alert.

Going back to step 340, if the amount difference for the last six months is greater than or equal to the threshold, the process advances to step 346, where the alerting system 24 determines whether the individual's TM Index score is greater than some threshold (e.g., 0.065). If the individual's TM Index score is greater than or equal to the applicable threshold, the process advances to step 344 where the alert is issued. Conversely, at step 346 the customer's TM Index score is less than the threshold, the process advances to step 348, where (similar to step 340) the alerting system 24 determines whether the amount difference over the last six months is greater than or equal to some threshold $Z (e.g., $3,000,000 USD). If so, an alert is issued at step 344. If no, the process advances to step 350, where the alerting system 24 can make a multi-prong, conjunctive determination. If the percentage of foreign transactions is greater than or equal to some threshold percentage P; and the six-month difference amount is greater than or equal to some threshold $C (e.g., $38,000); and the customer's TM Index score is greater than or equal to some threshold (e.g., 0.04); then an alert is issued at step 336. Otherwise, no alert is issued at step 334. Of course, in other embodiments, a different process flow can be used to determine whether or not to issue an alert based on the scenario.

When an alert is triggered, the alerting system 24 can send the alert electronically, via an electronic data network, to other systems of the financial institution for example. For example, a surveillance group within the financial institution can determine whether the scenario merits further review. If so, an investigations group can determine whether to make a suspicious activity report (SAR) or not based on the further review. A SAR a document that financial institutions, and those associated with their business, must file with the Financial Crimes Enforcement Network (FinCEN) whenever there is a suspected case of financial crime.

Returning to FIG. 1, the TM Index computation system 18 can compute TM Index scores for the financial institution's customers periodically, such as once a week. As such, the databases 14A-M preferably are updated with the most recent transaction data so that the latest periodic TM Index scores 70 are based on the latest transactional data. Also, the scenario generate system 104 (see FIG. 4) and the alerting system 24 can also be run periodically, such as once per week (e.g., after the updated TM Index scores are computed). The TM Index model can be trained or re-trained less frequently, such every six months or every year, for example.

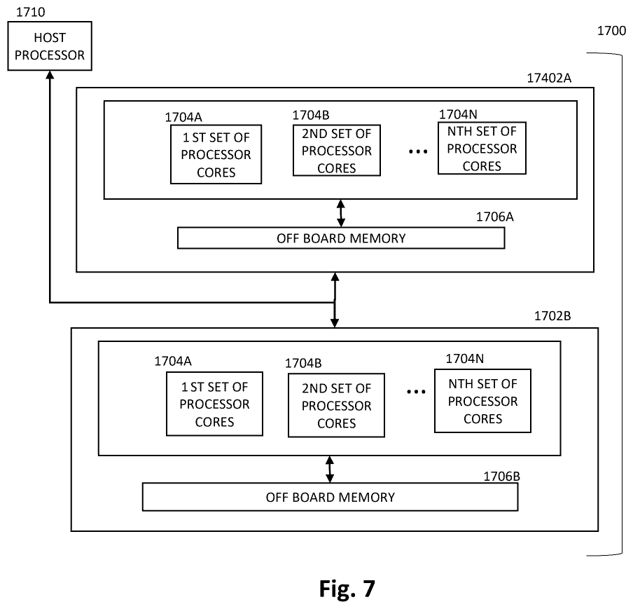

FIG. 7 is a diagram of the TM Index model training system 12 (see FIG. 1) according to various embodiments. The illustrated computer system 12 comprises multiple processor units 1702A-B that each comprises, in the illustrated embodiment, multiple (N) sets of processor cores 1704A-N. Each processor unit 1702A-B may comprise on-board memory (ROM or RAM) (not shown) and off-board memory 1706A-B. The on-board memory may comprise primary, volatile and/or non-volatile, storage (e.g., storage directly accessible by the processor cores 1704A-N). The off-board memory 1706A-B may comprise secondary, non-volatile storage (e.g., storage that is not directly accessible by the processor cores 1704A-N), such as ROM, HDDs, SSD, flash, etc. The processor cores 1704A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 1710 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 1704A-N may train the Light Gradient Boosted Tree Classifier described herein. One or more host processors 1710 may coordinate and control the processor units 1702A-B.

In other embodiments, the system 12 could be implemented with one processor unit 1702. In embodiments where there are multiple processor units, the processor units could be co-located or distributed. For example, the processor units 1702 may be interconnected by data networks, such as a LAN, WAN, the Internet, etc., using suitable wired and/or wireless data communication links. Data may be shared between the various processing units 1702 using suitable data links, such as data buses (preferably high-speed data buses) or network links (e.g., Ethernet).

The TM Index computation system 18, alerting system 24 and scenario generation system 104 may be implemented with computer devices, such as servers, with appropriately programmed software that, when executed, causes the computer devices to perform the functions described herein. The computer systems may comprise one or more processor cores and one or more computer memory units. The memory may comprise primary (memory directly accessible by the processor, such as RAM, processor registers and/or processor cache) and/or secondary (memory not directly accessible by the processor, such as ROM, flash, HDD, etc.) data storage, to store computer instruction or software to be executed by the processor core(s), such as the software for the TM Index computation system 18, alerting system 24 and scenario generation system 104.

The software for the various compute systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

In one general aspect, therefore, the present invention is directed to computer-implemented systems and methods for identifying potential financial crime activities by customers of a financial institution. In various embodiments, the system comprises a TM Index model training computer system for training, via machine learning, a TM Index model to compute an TM Index score for customers of the financial institution. The TM Index scores are numerical values over a range, where higher scores indicate more interestingness of the customer in terms of potential money-laundering activities. The TM Index model comprises a series of multiple decision trees, such that the TM Index score for an individual is a sum of an output of each of the series of multiple decision trees. The TM Index model training computer system is configured to train the TM Index model by determining a set of feature variables for the TM Index model, which can comprise iteratively determining, for each of a plurality of potential feature variables, whether performance of the model improves due to inclusion of the potential feature variable. The training also comprises selecting a set of training samples on which to train the TM Index model, which can include identifying, based at least in part on transaction data of the customers, customers in an area of interest for one or more money-laundering scenarios. The system also comprises a TM Index computation system for, after training of the TM Index model, periodically computing TM Index scores for the customers using the trained TM Index model. The system also comprises a scenario generation system for identifying one or more scenario alerts of potential financial crime activity by customers of the financial institution based on transaction data for the customers. The system also comprises an alerting computer system for determining, for each of the one more scenario alerts, whether a financial crime alert should be issued based on, at least, transaction data for the customer pertaining to the scenario alert and the TM Index score for the customer.

In one general aspect, the method comprises the step of training, by the TM Index model training computer system, via machine learning, the TM Index model to compute an TM Index score for customers of the financial institution. The TM Index scores are numerical values over a range, where higher scores indicate more interestingness of the customer in terms of potential money-laundering activities; and the TM Index model comprises a series of multiple decision trees, such that the TM Index score for an individual is a sum of an output of each of the series of multiple decision trees. The step of training the TM Index model further includes: (i) determining a set of feature variables for the TM Index model; and (ii) selecting a set of training samples on which to train the TM Index model. Determining the set of feature variables can comprise iteratively determining, for each of a plurality of potential feature variables, whether performance of the model improves due to inclusion of the potential feature variable. Selecting the set of training samples can include identifying, based at least in part on transaction data of the customers, customers in an area of interest for one or more money-laundering scenarios.

The method further comprises the step of periodically, after training the TM Index model, computing, by a TM Index computation system, TM Index scores for the customers using the trained TM Index model. The method also comprises the step of identifying, by a scenario generation system, one or more scenario alerts of potential financial crime activity by customers of the financial institution based on transaction data for the customers. And the method further comprises the step of, for each of the one more scenario alerts, determining, by an alerting computer system, whether a financial crime alert should be issued based on, at least, transaction data for the customer pertaining to the scenario alert and the TM Index score for the customer.

In various implementations, the TM Index model comprises a gradient boosting machine learning framework, such as a Light Gradient Boosted Tree model.

In various implementations, training the TM Index model comprises iteratively adding decision trees until a next tree in the iteration does not improve performance of the TM Index model beyond a threshold.

In various implementations, each decision node in the series of multiple decision trees comprises a test on one of the feature variables.

In various implementations, training the TM Index model comprises training the TM index model such that the TM index score is the sum of an output from each of the series of decision trees.

In various implementations, periodically computing the TM Index scores comprises computing the TM Index scores weekly.

In various implementations, the customers comprise persons, organizations, and corporations.

In various implementations, training the TM Index model comprises (i) training the TM index model with training samples; and (ii) selecting the training samples for the training, where selecting the training samples comprises selecting training samples that are within an area of interest for one or more predefined suspicious financial crime scenarios.

In various implementations, the set of feature variables comprise: counts of transaction types by a customer over a first lookback period; counts of the transaction types by the customer over a second, longer lookback period; cumulative transaction amounts for the transaction types over the first lookback period; and cumulative transaction amounts for the transaction types over the second lookback period.

In various implementations, the one more scenario alerts comprises a first scenario alert for a first customer and a second scenario alert for a second customer, where the first scenario alert is for a different scenario type than the second scenario alert. In such a case, determining whether a financial crime alert should be issued for each of the first and second scenario alerts comprises: (i) performing a first analysis for the first scenario type, where the first analysis is particular to the first scenario type; and (ii) performing a second analysis for the second scenario type, where the second analysis is particular to the second scenario type, such that: (a) the first and second analyses have different decision flows; (b) the first analysis comprises at least one decision point that is based on the TM Index score for the first customer; and (c) the second analysis comprises at least one decision point that is based on the TM Index score for the second customer.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A computer-implemented method for identifying potential financial crime activities by customers of a financial institution, the method comprising:
training, by a TM Index model training computer system, via machine learning, a TM Index model to compute an TM Index score for customers of the financial institution, wherein:
the TM Index scores are numerical values over a range, where higher scores indicate more interestingness of the customer in terms of potential money-laundering activities;
the TM Index model comprises a series of multiple decision trees, such that the TM Index score for an individual is a sum of an output of each of the series of multiple decision trees; and
training the TM Index model includes:
determining a set of feature variables for the TM Index model, wherein determining the set of feature variables comprises iteratively determining, for each of a plurality of potential feature variables, whether performance of the model improves due to inclusion of the potential feature variable; and
selecting a set of training samples on which to train the TM Index model, wherein selecting the set of training samples includes identifying, based at least in part on transaction data of the customers, customers in an area of interest for one or more money-laundering scenarios; and
periodically, after training the TM Index model:
computing, by a TM Index computation system, TM Index scores for the customers using the trained TM Index model;
identifying, by a scenario generation system, one or more scenario alerts of potential financial crime activity by customers of the financial institution based on transaction data for the customers; and
for each of the one more scenario alerts, determining, by an alerting computer system, whether a financial crime alert should be issued based on, at least, transaction data for the customer pertaining to the scenario alert and the TM Index score for the customer.

2. The method of claim 1, wherein the TM Index model comprises a gradient boosting machine learning framework

3. The method of claim 2, wherein the TM Index model comprises a Light Gradient Boosted Tree model.

4. The method of claim 2, wherein training the TM Index model comprises iteratively adding decision trees until a next tree in the iteration does not improve performance of the TM Index model beyond a threshold.

5. The method of claim 4, wherein each decision node in the series of multiple decision trees comprises a test on one of the feature variables.

6. The method of claim 5, wherein training the TM Index model comprises training the TM index model such that the TM index score is the sum of an output from each of the series of decision trees.

7. The method of claim 1, wherein periodically computing the TM Index scores comprises computing the TM Index scores weekly.

8. The method of claim 1, wherein the customers comprise persons, organizations, and corporations.

9. The method of claim 1, wherein training the TM Index model comprises:
training the TM index model with training samples; and
selecting the training samples for the training, wherein selecting the training samples comprises selecting training samples that are within an area of interest for one or more predefined suspicious financial crime scenarios.

10. The method of claim 1, wherein the set of feature variables comprise:
counts of transaction types by a customer over a first lookback period;
counts of the transaction types by the customer over a second, longer lookback period;
cumulative transaction amounts for the transaction types over the first lookback period; and
cumulative transaction amounts for the transaction types over the second lookback period.

11. The method of claim 1, wherein:
the one more scenario alerts comprises a first scenario alert for a first customer and a second scenario alert for a second customer, wherein the first scenario alert is for a different scenario type than the second scenario alert; and
determining whether a financial crime alert should be issued for each of the first and second scenario alerts comprises:
performing a first analysis for the first scenario type, where the first analysis is particular to the first scenario type; and
performing a second analysis for the second scenario type, where the second analysis is particular to the second scenario type,
such that:
the first and second analyses have different decision flows;
the first analysis comprises at least one decision point that is based on the TM Index score for the first customer; and
the second analysis comprises at least one decision point that is based on the TM Index score for the second customer.

12. A system for identifying potential financial crime activities by customers of a financial institution, the system comprising:
a TM Index model training computer system for training, via machine learning, a TM Index model to compute an TM Index score for customers of the financial institution, wherein:
the TM Index scores are numerical values over a range, where higher scores indicate more interestingness of the customer in terms of potential money-laundering activities;
the TM Index model comprises a series of multiple decision trees, such that the TM Index score for an individual is a sum of an output of each of the series of multiple decision trees; and
the TM Index model training computer system is configured to train the TM Index model by:
determining a set of feature variables for the TM Index model, wherein determining the set of feature variables comprises iteratively determining, for each of a plurality of potential feature variables, whether performance of the model improves due to inclusion of the potential feature variable; and
selecting a set of training samples on which to train the TM Index model, wherein selecting the set of training samples includes identifying, based at least in part on transaction data of the customers, customers in an area of interest for one or more money-laundering scenarios; and
a TM Index computation system for, after training of the TM Index model, periodically computing TM Index scores for the customers using the trained TM Index model;
a scenario generation system for identifying one or more scenario alerts of potential financial crime activity by customers of the financial institution based on transaction data for the customers; and
an alerting computer system for determining, for each of the one more scenario alerts, whether a financial crime alert should be issued based on, at least, transaction data for the customer pertaining to the scenario alert and the TM Index score for the customer.

13. The system of claim 12, wherein the TM Index model comprises a gradient boosting machine learning framework

14. The system of claim 13, wherein the TM Index model comprises a Light Gradient Boosted Tree model.

15. The system of claim 13, wherein training the TM Index model comprises iteratively adding decision trees until a next tree in the iteration does not improve performance of the TM Index model beyond a threshold.

16. The system of claim 15, wherein each decision node in the series of multiple decision trees comprises a test on one of the feature variables.

17. The system of claim 16, wherein training the TM Index model comprises training the TM index model such that the TM index score is the sum of an output from each of the series of decision trees.

18. The system of claim 12, wherein training the TM Index model comprises:
training the TM index model with training samples; and
selecting the training samples for the training, wherein selecting the training samples comprises selecting training samples that are within an area of interest for one or more predefined suspicious financial crime scenarios.

19. The system of claim 12, wherein the set of feature variables comprise:
counts of transaction types by a customer over a first lookback period;
counts of the transaction types by the customer over a second, longer lookback period;
cumulative transaction amounts for the transaction types over the first lookback period; and
cumulative transaction amounts for the transaction types over the second lookback period.

20. The system of claim 12, wherein:
the one more scenario alerts comprises a first scenario alert for a first customer and a second scenario alert for a second customer, wherein the first scenario alert is for a different scenario type than the second scenario alert; and
determining whether a financial crime alert should be issued for each of the first and second scenario alerts comprises:
performing a first analysis for the first scenario type, where the first analysis is particular to the first scenario type; and
performing a second analysis for the second scenario type, where the second analysis is particular to the second scenario type,
such that:
the first and second analyses have different decision flows;
the first analysis comprises at least one decision point that is based on the TM Index score for the first customer; and
the second analysis comprises at least one decision point that is based on the TM Index score for the second customer.
